(19) United States
(12) Patent Application Publication
(10) Pub. No.: US 2005/0244216 A1
(43) Pub. Date: Nov. 3, 2005

(54) Coupler

(76) Inventor: Michael Magraw, Manteca, CA (US)

Correspondence Address: WOOD, NGO & EISENBERG, PLLC, 2121 Eisenhower Ave, Suite 200, Alexandria, VA, 22314, US

(21) Appl. No.: 10/834,074

(22) Filed: Apr. 29, 2004

(51) Int. Cl. F16D 1/00

(52) U.S. Cl. 403/307

(57) ABSTRACT

A coupler for coupling first and second elongated members end to end. In a first embodiment the coupler comprises a cylinder and at least one section of hardener and resin, wherein the cylinder has a single bore with first and second opposite open ends of predetermined diameter. In another embodiment, the coupler comprises a dividing wall that splits the cylinder into first and second bores, wherein at least one section of hardener and resin is located in each bore.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to a coupler in combination with a bonding system for joining two opposing elongated members end to end.

U.S. Pat. No. 5,785,462 issued Jul. 28, 1998 to Hein et al, describes a self-contained anchoring multi-component cartridge that couples a metal anchoring rod to a borehole. The multi-component cartridge comprised resin in an inner cartridge and a hardener component in an outer cartridge. The multi-component cartridge is inserted inside an annular space or borehole with the inside width of the borehole corresponding to at least the wall thickness of the multi-component cartridge. The cartridge is crushed mixing and thereby activating the hardener and resin to couple an anchoring rod to a borehole (col. 2, lines 21-37). The '462 device does not teach or suggest a coupler in combination with a bonding system capable of coupling two opposing elongated members end to end.

U.S. Pat. No. 6,481,571 issued Nov. 19, 2002 to Kelders et al, describes a dual component container for separately storing two liquids, which are intermixed within the self-contained system prior to being dispensed. The relative movement of the containers removes the seal separating the liquids causing the two liquids to mix. The '571 device does not teach or suggest a two-component bonding system capable of bonding two opposing elongated members end to end to the coupler.

U.S. Pat. No. 5,763,026 issued Jun. 9, 1998 to Makino et al, discloses an anchor-fixing capsule comprising a crushable capsule, and a hardenable resin component and a powdery or granular hardener component with which the crushable capsule is filled. The hardenable resin component is separated from the hardener component by a separation layer. The hardenable resin component and hardener components are each alternately disposed in two or more layers that provide uniform good mixing of the hardenable resin component and the hardener component upon contact with an anchor resulting in good adhesive strength of the anchor. The layers of hardener and resin can be housed in a glass capsule. The '026 device does not teach or suggest a bonding system capable of linking two elongated members end to end to the coupler.

U.S. Pat. No. 4,857,131 issued Aug. 15, 1989 to Damico et al, shows a two-part adhesive that can be mixed in equal parts with rapid cure for the bonding of metal (col. 2, lines 55-60) or plastics (abstract). The '131 device does not teach or suggest a bonding system capable of linking two elongated members end to end to the coupler.

U.S. Pat. No. 5,351,998 issued Oct. 4, 1994 to Behrens et al, describes a coupling device for maximum pressure-tight threaded pipe connectors, comprising a sealing means, such as a sealing ring, and a holding ring. The sealing means is connected to the sealing ring by an adhesive (claim 3). The '998 device does not teach or suggest a coupler containing a bonding system capable of linking two elongated members end to end to the coupler.

None of the above inventions and patents, taken either singly or in combination, is seen to describe the instant invention as claimed.

### SUMMARY OF THE INVENTION

A coupler for coupling first and second elongated members end to end. In a first embodiment the coupler comprises a cylinder and at least one section of hardener and resin, wherein the cylinder has a single bore with first and second opposite open ends of predetermined diameter. In another embodiment, the coupler comprises-a dividing wall that splits the cylinder into first and second bores, wherein at least one section of hardener and resin is located in each bore.

Accordingly, it is a principal object of the invention to provide a coupler for coupling together the ends of two elongated members.

This and other objects of the present invention will become readily apparent upon further review of the following specification and drawings.

### BRIEF DESCRIPTION OF THE DRAWINGS

FIG. 1A is a perspective view of a coupler of circular cross-section according to the present invention.

FIG. 1B is a perspective view of a coupler of polygonal cross section according to the present invention.

FIG. 2A is an exploded view of a coupler with a single through bore according to the first principal of the present invention.

FIG. 2B is an exploded view of a coupler with a first and second bore according to the second principal embodiment of the present invention.

FIG. 3A is a longitudinal section view of a coupler with layers of hardener and resin and separated by a frangible layer according to the second embodiment of the present invention.

FIG. 3B is a longitudinal section view of a coupler with a bilayer of hardener and resin located in each bore according to the second embodiment of the present invention.

FIG. 3C is a longitudinal section view of a coupler according to the invention.

FIG. 4 is a longitudinal section view of a coupler with a trilayer of resin and hardener located in each bore according to the second embodiment of the present invention.

FIG. 5A is a longitudinal section view of a coupler with a coplanar layer of resin and hardener according to the second embodiment of the present invention.

FIG. 5B is a longitudinal section view of a coupler according to the second embodiment of the present invention.

FIG. 6A is a longitudinal section view of a coupler according to the second embodiment of the present invention.

FIG. 6B is a longitudinal section view of a coupler according to the second embodiment of the present invention.

FIG. 6C is a longitudinal section view of a coupler according to the second embodiment of the present invention.

Similar reference characters denote corresponding features consistently throughout the attached drawings.

### DETAILED DESCRIPTION OF THE PREFERRED EMBODIMENTS

The present invention relates to a coupler in combination with a bonding system to couple or link together the ends of two elongated members.

It should be understood that in the first preferred embodiment, and variations or derivatives thereof, the term “cylinder” means a single bore with two opposite open ends, wherein the single bore has a cross-section that can take various forms such as, but not limited to: circular, square, rectangular, polygonal (including both regular and irregular polygonal shaped cross-sections such as an irregular hexagon shape), and elliptical (e.g., oval shape).

It should be understood that in the second preferred embodiment, and variations or derivatives thereof, the term “cylinder” means a cylinder with an internal space divided by a dividing wall to create a first and second bore each with an open end distal from the dividing wall, wherein the first and second bores each have a cross-section that can take various forms such as, but not limited to: circular, square, rectangular, polygonal (including both regular and irregular polygonal shaped cross-sections such as an irregular hexagon shape), and elliptical (e.g., oval shape).

It should be understood that the term “bonding system” as used herein means a bonding system that comprises at least one section comprising a resin component and at least one section comprising a hardener component, such that the resin component is capable of hardening upon mixing with the hardener component, i.e., the hardener acts as a hardening or curing agent with respect to the resin component.

The process of hardening is sometimes referred to as curing and using this terminology the resin component may be referred to as the curable agent, and the hardener component as the curing agent. Thus, the terms “curable agent” and “resin” are regarded as equivalent terms; also, the terms “hardener” and “curing agent” are regarded as equivalent terms.

It should also be understood that the term “non-interacting amounts of hardener and resin” refers to one section comprising of hardener and at least one section comprising of resin, wherein the sections are not interacting with each other to the extent that the hardener is not hardening or curing the resin in a substantial way, i.e. at least 90% of the resin remains susceptible to hardening upon mixing with the hardener. The non-interacting amounts of hardener and resin are positioned in such a manner that the hardener and resin mix together upon contact with the end of an elongated member as described below. The term “interacting amounts of hardener and resin” refers to what happens when the resin and hardener mix, i.e. the hardener is caused to mix with the resin and thereby harden or cure the resin.

The term “section” is intended to mean any partitioned space that, for example, separately comprises an amount of resin or hardener. The sections can take the form of a layer, e.g., a layer (i.e., section) of resin. A separation layer can separate layers of resin and hardener. In addition, the sections can take the form of a several layers such as a first layer of resin following by a first separation layer followed by a second layer of hardener followed by a second separation layer, followed by a second layer of resin, followed by a third separation layer, followed by a third layer of hardener. The hardener, resin and separator layers may be stacked upon each other. In addition, there is no particular limitation on the order of formation of the resin and the hardener layers. Alternatively, the sections of resin and hardener can be in separate capsules positioned around the interior of the coupler of the present invention.

Sections of hardener and resin can be coplanar, i.e. a coplanar layer comprising a section of hardener and a section of resin. A separation layer optionally separates the sections of hardener and resin in the coplanar layer. Thus, the exact arrangement of hardener and resin sections in the coupler can vary considerably.

The layers can be incorporated in a housing such as a capsule. If used, the capsule should comprise of a material that is crushable upon application of a mechanical force. Thus, the capsule may be made of any suitable material that can house layers of resin and hardener, and break or crush upon contact with a mechanical force without detrimentally interfering in the curing of the resin by the hardener. For example, the capsule may be made of crushable glass.

One or more crushable capsules may be used in which the capsule interiors are each divided into two parts separately containing the resin and hardener components. One or more of these two-part capsules may be used in the coupler of the present invention.

It will be understood that the term “two-component bonding system” is not intended to be limited to just one section of resin and one section of hardener. Thus, the term “two-component bonding system” is intended to cover one or more sections comprising of resin and one or more sections comprising of hardener with separation layers as required. The sections should be in close proximity or brought into close proximity to facilitate mixing of the resin and hardener in response to the application of a mechanical force, as discussed below.

In the present invention, the resin component is capable of hardening upon mixing with the hardener component 140. Suitable resins include unsaturated polyester resins, epoxyacrylate resins, and epoxy resins. Suitable epoxy resins epoxynovolak such as polyorthocresol formaldehyde poly(2,3-epoxypropyl)ether or polyphenol formaldehyde poly(2,3-epoxypropyl)ether, epoxy resins obtained from the reaction of bisphenol A or resorcinol and epihalohydrin. Further examples include epoxidated polyolefine and an epoxy resin derived from phthalic anhydride and epihalohydrin. The resin is preferably a room temperature curable epoxy resin as disclosed in U.S. Pat. No. 4,447,579.

The hardener component can be any hardener that upon mixing with the resin component causes the resin component to harden. Suitable resins and hardeners include those that interact without requiring artificial heating such as an epoxy resin containing an average of more than one epoxy group per molecule and a polyamide-amine hardener which is obtained by the reaction of a diene rubber having terminal carboxyl groups and the reaction product of an aliphatic polyamine and one or two compounds containing carboxyl groups selected from the group consisting of tall acid and polymerized fatty acid hardener as disclosed in U.S. Pat. No. 4,447,579 issued May 8, 1984 to Takagi et al; the Takagi '579 patent is herein incorporated by reference in its entirety. Other suitable two-component epoxy-based adhesive systems include those disclosed in U.S. Pat. No. 6,645,341 issued Nov. 11, 2003 to T. Gordon; the Gordon '341 patent is herein incorporated by reference in its entirety.

In addition, there is no particular limitation on the order of formation of the resin and the hardener layers in the crushable capsule. It is preferred that there is at least one layer of hardener and at least one layer of resin. More preferably there is at least two alternating layers of hardener and resin, e.g. a layer of resin then a layer of hardener then a layer of resin then a layer of hardener. In another alternative arrangement of layers, a middle layer of hardener is sandwiched between first and second layers of resin; thus the middle layer of hardener is used to cure the first and second layers of resin.

Referring now to the Figures.

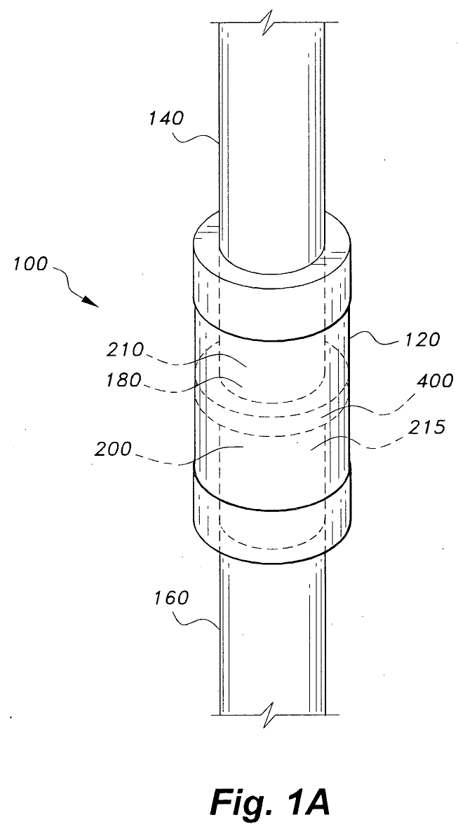

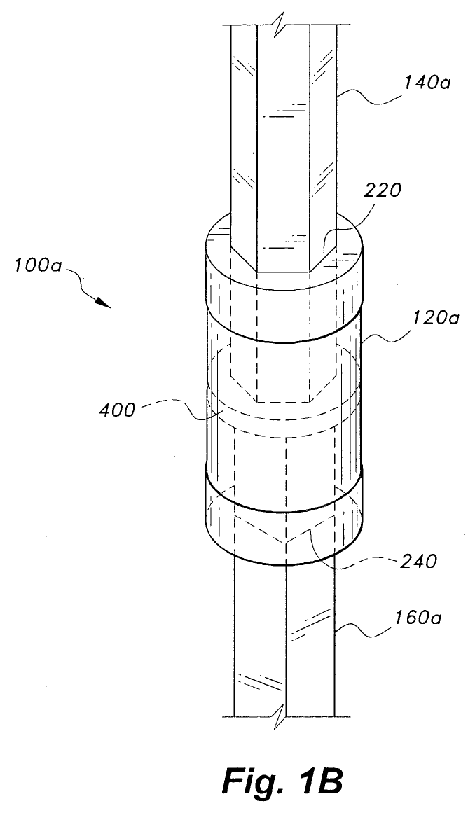

FIG. 1A shows a coupler 100, according to the invention. The coupler 100 comprises an essentially hollow cylinder 120 in which first 140 and second 160 generally tubular elongated members are coupled together. Specifically, the first 140 and second 160 elongated members respectively comprise ends 180 and 200 (shown in phantom). The ends 180 and 200 respectively define exterior surfaces 210 and 215. External surfaces 210 and 215 might be threaded, grooved or smooth. The device 100 is designed to accommodate ends 180 and 200 that might be of generally circular cross-section (as shown in FIG. 1A) or of different cross-section shapes as detailed below.

FIG. 1B shows a perspective view of the coupler 100 (represented by alpha-numeric “101a”) modified to hold together two elongated members 140a and 160a of polygonal cross section.

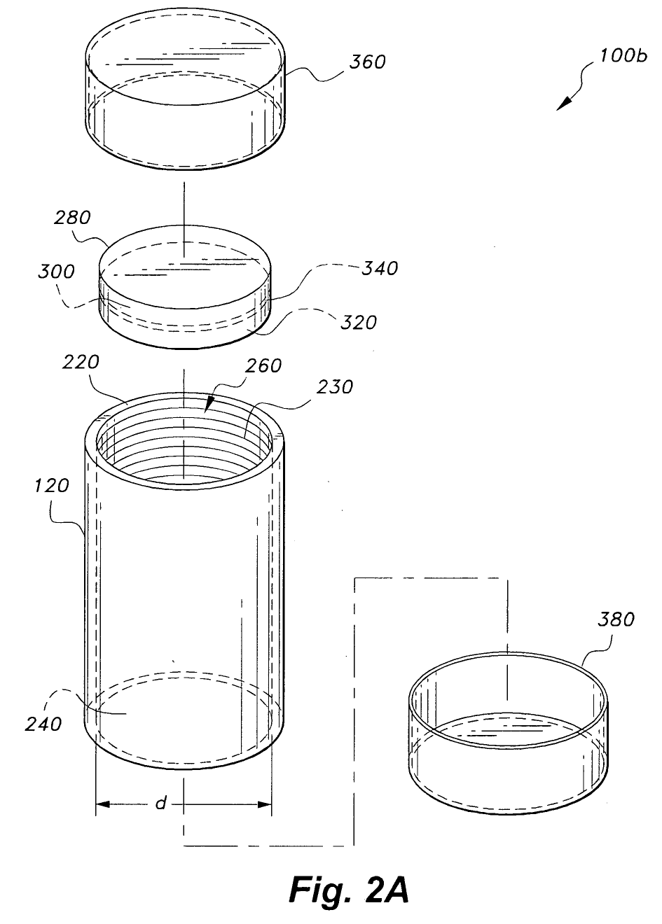

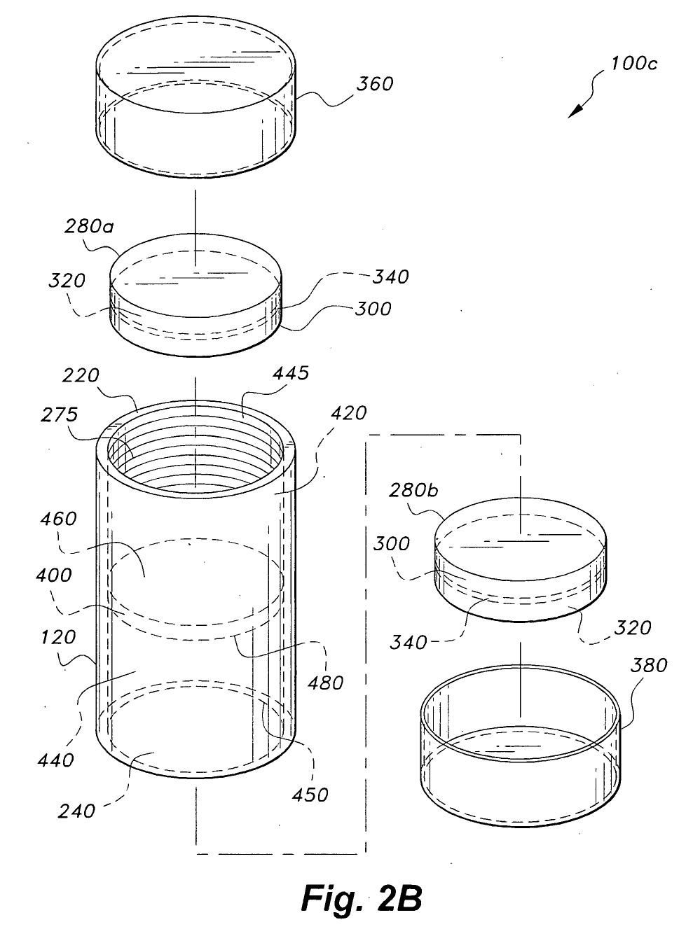

FIG. 2A shows an exploded perspective view of the first embodiment of the coupler 100 (represented by alpha-numeric “100b”). Coupler 100b comprises a cylinder 120 having first 220 and second 240 opposite open ends of predetermined diameter “d”. In this embodiment, cylinder 120 has a single bore 260; the single bore 260 can have a variety of cross-section shapes including, but not limited to, circular, triangular, square, and regular or irregular polygonal in order to accommodate a variety of cross-sections with respect to the elongated member ends 180 and 200. In addition, the single bore 260 can be smooth or lined with a thread 230.

The remaining Figures relate to the second principal embodiment of the present invention and variations or derivatives thereof.

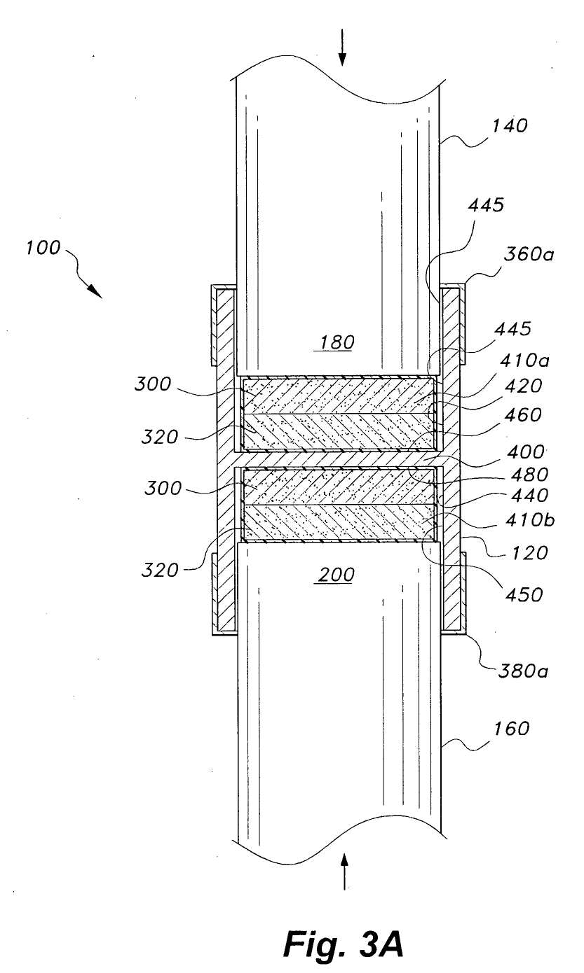

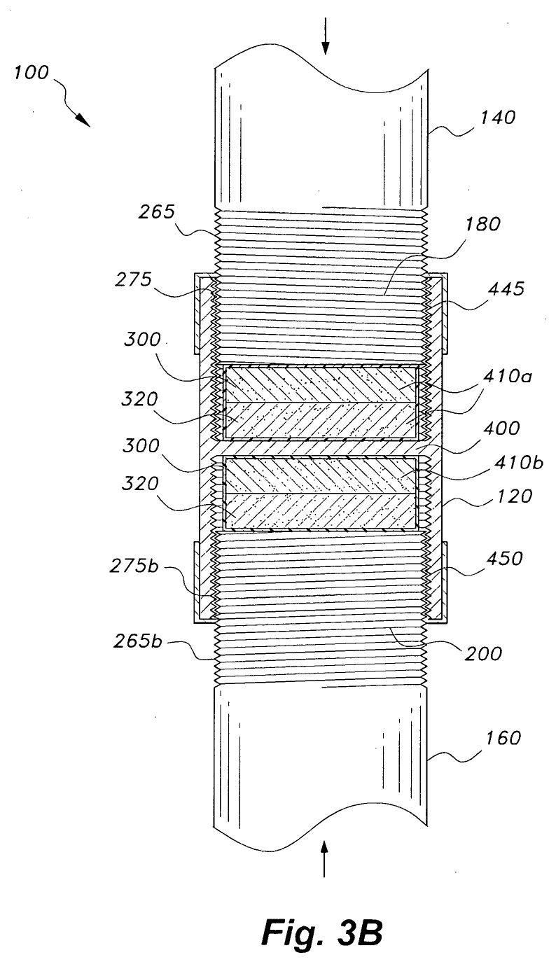

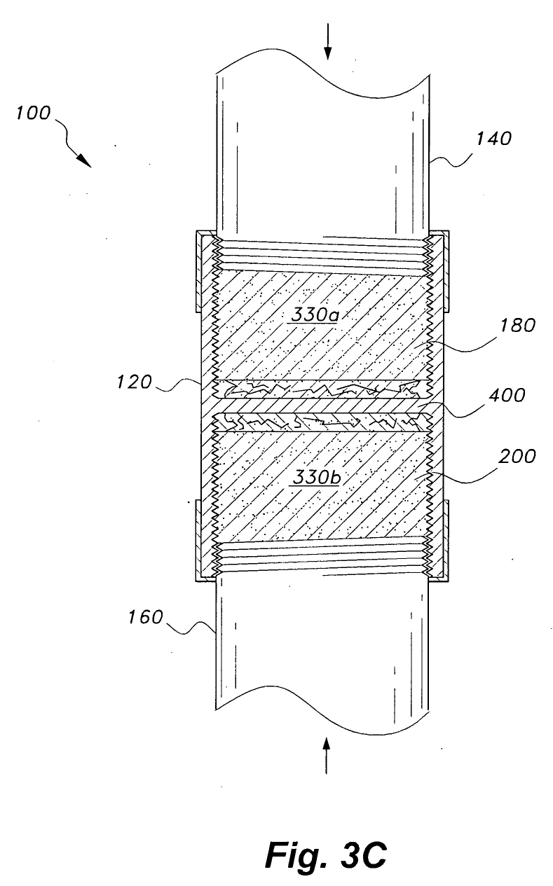

Still referring to FIG. 2A, a trilayer 280 is affixed about midway along the single bore 260. Trilayer 280 comprises hardener 300 and resin 320 layers separated by a frangible layer 340. The frangible layer 340 is easily disrupted upon contact with the elongated member ends 180 and 200; the contact may take any suitable form such as bumping and/or twisting the ends 180 and 200 into the frangible layer 340. Disrupting the frangible layer 340 causes the hardener layer 300 to mix with the resin layer 340 thereby initiating hardening of the resin. It will be understood that the cylinder 120, and more. particularly the opposite open ends 220 and 240, can adopt varied cross-sectional shapes, e.g., circular (FIG. 1A) and polygonal (FIG. 1B). In addition, the opposite open ends 220 and 240 can be lined internally with thread 230 or have a smooth internal surface. Optional caps 360 and 380 are respectively fitted over the open ends 220 and 240. Optional caps 360 and 380 are useful in keeping dirt out of the cylinder 120 and otherwise possibly contaminating the trilayer 280. The caps 360 and 380 are, preferably easy to perforate or remove from the cylinder ends 220 and 240; for example, perforated caps 360a and 380a are shown in FIG. 3A.

FIG. 2B shows an exploded perspective view of the second embodiment of the coupler 100 (represented by alpha-numeric “100c”). Coupler 100c comprises a cylinder 120 having first 220 and second 240 opposite open ends of predetermined diameter d. In this embodiment a dividing wall 400 divides cylinder 120 into first 420 and second 440 bores; the bores 420 and 440 respectively comprise inner bore walls 445 and 450.

It will be understood that the cylinder 120 comprises open ends 220 and 240 and first 420 and second 440 bores that can be of any type of required cross-section shape such as circular, triangular, square, and regular or irregular polygonal shape to accommodate elongated member ends 180 and 200 of varying cross-section shape (see, e.g., FIG. 1B). Thus, device 100 is designed to couple together the ends 180 and 200 of a wide variety of elongated members such as the ends of steel rods, tubular scaffolding members, elongated members with ends of varying cross-section profiles such as circular, triangular, square, and regular or irregular polygonal shaped ends. The ends 180 and 200 may be solid or comprise a bore. The external surfaces 210 and 215 (see FIG. 1A) of ends 180 and 200 may be grooved, threaded or smooth.

Still referring to FIG. 2B, dividing wall 400 comprises a first surface 460 and a second surface 480. First bore 420 extends between the first surface 460 and the first opposite open end 220 of the cylinder; second bore 440 extends between the second surface 480 and the second opposite open end 240 of the cylinder 120. Both bores 420 and 440 can be smooth bores (e.g., see FIG. 3A) or threaded for receiving smooth or threaded ends 180 and 200. For example, in FIG. 2B bore 420 is shown lined with thread 275; and in FIG. 3B inner bore walls 445 and 450 respectively have threads 275a and 275b, while ends 180 and 200 respectively have threads 265a and 265b. Alternatively, the first bore 420 is not threaded and the second bore 440 is threaded, or the first bore 420 is threaded and the second bore 440 is not threaded. First 280a and second 280b trilayers are respectively affixed to first 460 and second 480 surfaces of the dividing wall 400. Optional caps 360 and 380 are respectively fitted over the open ends 220 and 240.

Coupler 100 is made of any suitable material such as metal or metal alloy. For example, where mechanical stresses are likely the coupler 100 is preferably made of steel. Where stresses are likely to be minimal, the coupler 100 may be made of, for example, aluminum. In some applications, such as joining together elongated members that will not experience high loads, coupler 100 can be made of a resilient or reinforced plastic polymer; in some applications the coupler 100 can be made of a material such as a flexible yet resilient plastic that can bend without loosing overall integrity.

The dividing wall 400 can be made of a dissimilar or same material as the cylinder 120. In some applications it will be important that the dividing wall 400 is sufficiently robust to prevent the ends 180 and 200 of elongated members 140 and 160 passing beyond the midpoint of the coupler 100, i.e., through the first bore 420 and into the second bore 440 and vice versa. In other applications the dividing wall 400 may be made of a frangible material which can act, for example, as aggregate for mixing with the hardener and resin by, for example, contacting and twisting ends 180 and 200 into the dividing wall 400. In some applications, the dividing wall 400 may be unnecessary in which case the dividing wall 400 is not included in the coupler 100 as shown in FIG. 2A.

In FIG. 3A, the hardener 300 and resin 320 sections form a bilayer 410 (represented by alpha-numerals “410a” and “410b” in each bore 420 and 440. The inner bore walls 445 and 450 are both smooth as shown in FIG. 3A; however, the bore walls 445 and 450 might be smooth and threaded, respectively, and vice versa. Alternatively, the bore walls 445 and 450 are both threaded as shown in FIG. 3B.

When the elongated members 140 and 160 are pushed (and possibly rotated or twisted) into the cylinder 120 until the ends 180 and 200 abut or rest close to the dividing wall 400, the sections of hardener 300 and resin 320 are crushed and mixed to form a mixture of hardener and resin 330 (represented by alpha-numerals “330a” and “330b”) which respectively covers the ends 180 and 200 as shown in FIG. 3C. Once the mixture 330 hardens the ends 180 and 200 are firmly held in place inside the bores 420 and 440, respectively.

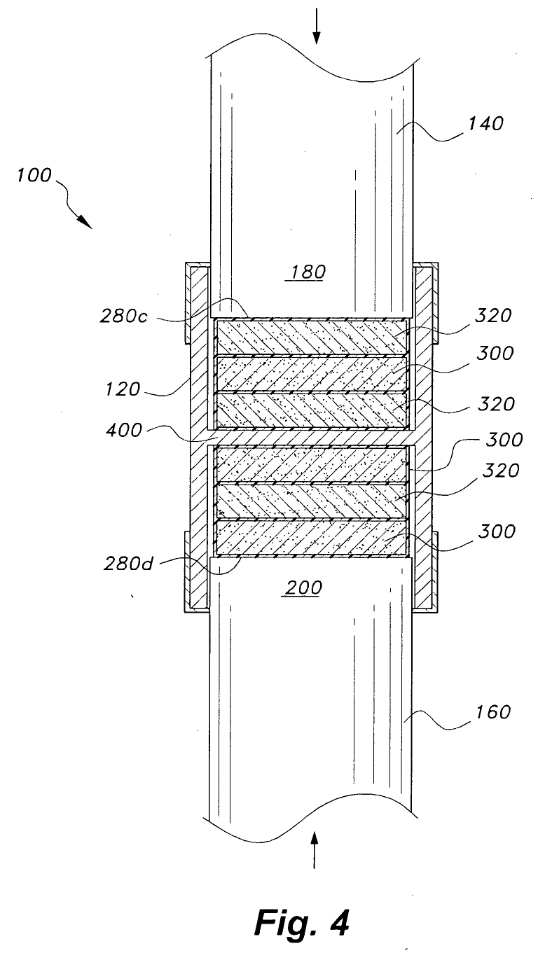

A trilayer 280 of hardener 300 and resin 320 sections are shown in FIG. 4. Specifically, trilayer 280c comprises a layer of hardener 300 sandwiched between layers of resin 320; and trilayer 280d comprises a layer of resin 320 sandwiched between layers of hardener 300.

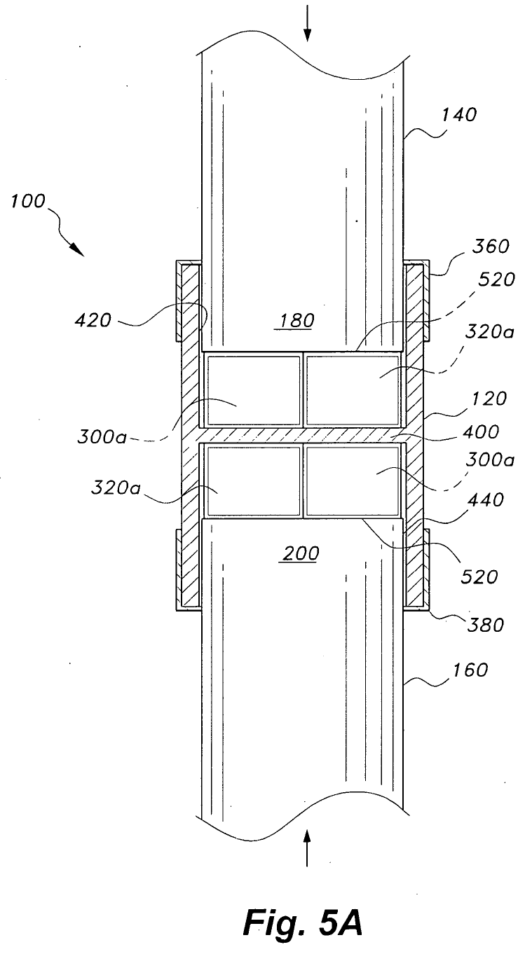

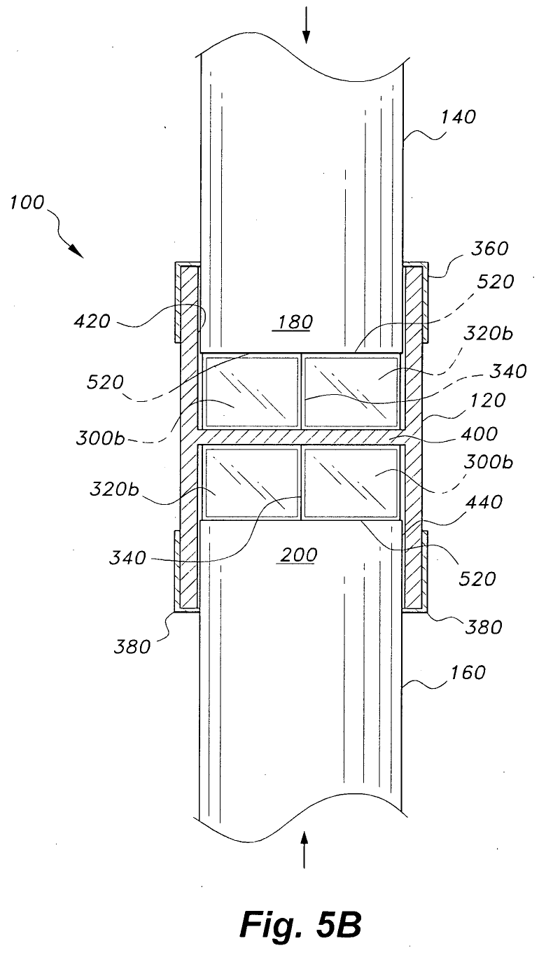

With regard to FIG. 5A, the sections of resin and hardener can be located in a coplanar layer 520 in at least one of the two bores 420 and 440. Specifically, the coplanar layer 520 takes the form of non-interacting sections of hardener 300a and resin 320a. In FIG. 5B, the coplanar layer 520 comprises a section of hardener 300b and a section of resin 320b separated by a frangible wall section 340.

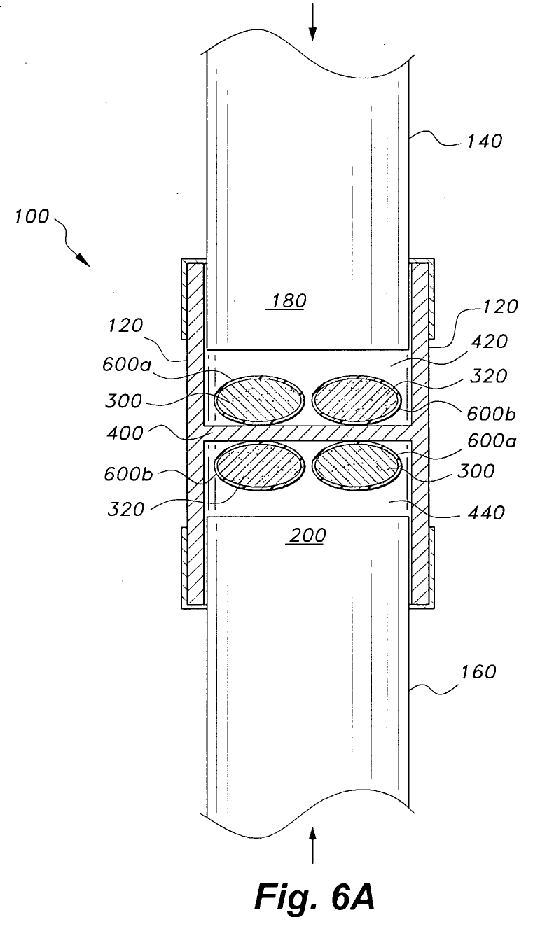

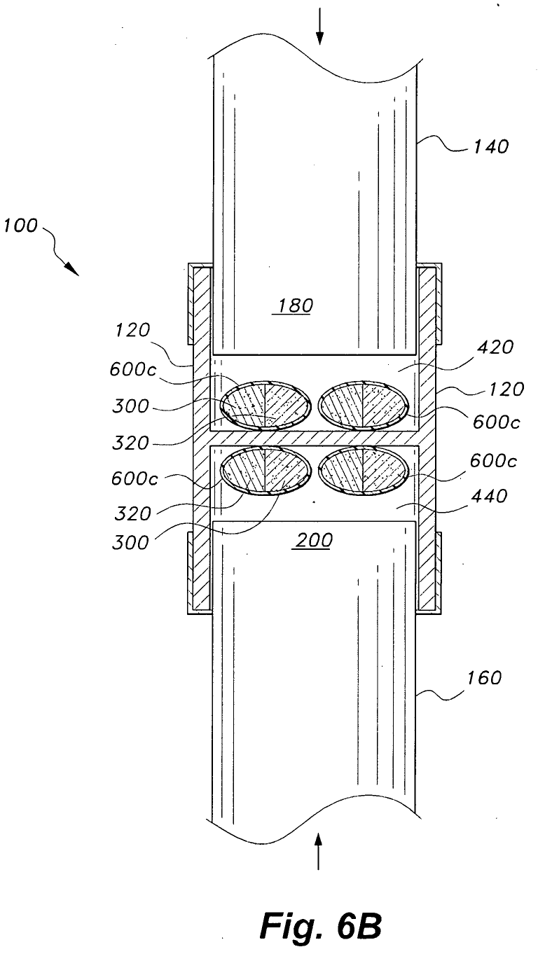

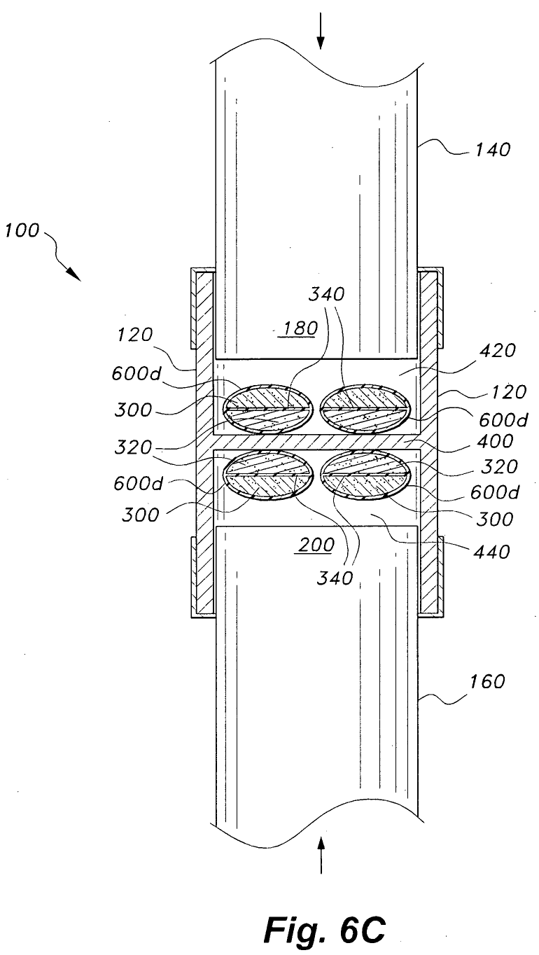

Alternatively, the sections of hardener and resin can be located in at least one capsule 600a containing hardener 300 and at least one capsule 600b containing resin 320 (see FIG. 6A). In another variation, capsules 600c comprise non-interacting amounts of hardener 300 and resin 320 (FIG. 6B). In a still further variation (FIG. 6C), capsules 600d comprise a trilayer of hardener 300 and resin 320 portions separated by a frangible layer 340. The capsules 600 (i.e., 600a, 600b, 600c, 600d, alone or in combination) can be affixed to the sides of the single bore 260 (FIG. 2A) or to the inner bore walls 445 and 450 (FIG. 2B).

It is to be understood that the present invention is not limited to the embodiments described above, but encompasses any and all embodiments within the scope of the following claims.

1. A coupler for coupling first and second elongated members end to end, the coupler comprising:
a cylinder having a single bore with first and second opposite open ends of predetermined diameter;
at least one section of hardener and at least one section of resin located in the bore.

2. The coupler according to claim 1, wherein the opposite open ends are threaded.

3. The coupler according to claim 1, wherein the cylinder has a circular cross-section shape.

4. The coupler according to claim 1, wherein the cylinder has a polygonal cross-section shape.

5. The coupler according to claim 1, wherein the cylinder has an elliptical cross-section shape.

6. A coupler for joining a first and second elongated members end to end, the coupler comprising:
a cylinder having first and second opposite open ends of predetermined diameter;
a dividing wall having first and second opposite surfaces, wherein the dividing wall splits the cylinder into first and second bores, wherein the first bore extends between the first surface of the dividing wall and the first opposite open end of the cylinder, wherein the second bore extends between the second surface of the dividing wall and the second opposite open end of the cylinder;
at least one section of hardener located in each bore; and
at least one section of resin located in each bore.

7. The coupler according to claim 6, wherein the first and second bores are both threaded or both not threaded, or a combination of the two such that the first bore is not threaded and the second bore is threaded, or the first bore is threaded and the second bore is not threaded.

8. The coupler according to claim 6, wherein the hardener and resin sections of each bore are arranged in layers such that the layers in the first bore are in contact with the first surface of the dividing wall, and the layers in the second bore are in contact with the second surface of the dividing wall.

9. The coupler according to claim 8, wherein a separation layer is located between each layer of hardener and resin.

10. The coupler according to claim 6 further comprising at least one coplanar layer in at least one of the two bores, wherein the coplanar layer comprises a section of hardener and a section of resin.

11. The coupler according to claim 6 further comprising at least one coplanar layer in at least one of the two bores, wherein the coplanar layer comprises non-interacting amounts of hardener and resin.

12. The coupler according to claim 6 further comprising at least one coplanar layer in at least one of the two bores, wherein the coplanar layer comprises a section of hardener and a section of resin, and further wherein each coplanar layer comprises a frangible wall section that separates the hardener and resin sections.

13. The coupler according to claim 6, wherein each bore comprises at least one capsule containing resin and at least one capsule containing hardener.

14. The coupler according to claim 6, wherein each bore comprises at least one capsule, wherein the at least one capsule in each bore contains non-interacting amounts resin and hardener.

15. The coupler according to claim 6, wherein each bore comprises at least one capsule, wherein the at least one capsule in each bore contains non-interacting amounts resin and hardener, wherein the non-interacting amounts resin and hardener are separated by a frangible layer.

16. The coupler according to claim 6, wherein each bore comprises at least one layer of resin and at least one layer of hardener.

17. The coupler according to claim 6, wherein the first and second bores respectively have first and second inner bore walls, wherein at least one of the hardener and resin sections are in contact with at least one of the first and second inner bore walls.
